(19) United States
(12) Patent Application Publication
(10) Pub. No.: US 2008/0222157 A1
(43) Pub. Date: Sep. 11, 2008

(54) Information providing method and information providing system

(75) Inventors: Masami Watanabe, Kawasaki (JP); Hirohisa Fukuyama, Yokohama (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/899,618

(22) Filed: Sep. 6, 2007

Related U.S. Application Data
(63) Continuation of application No. PCT/JP05/03890, filed on Mar. 7, 2007.

(51) Int. Cl. G06F 17/30

(52) U.S. Cl. 707/10; 707/E17.01

(57) ABSTRACT

An information-requesting terminal includes a transmission control unit that controls a transmission of an information acquisition request including an address of a requested Web page before collection and generation information or management information with which the generation information can be identified to a Web archive server. The Web archive server includes an information providing unit that extracts a Web page corresponding to the address of the Web page and the generation information or the management information received from the transmission control unit from a Web archive, and provides extracted Web page to the information-requesting terminal.

### BACKGROUND OF THE INVENTION

1. Field of the Invention

The present invention relates to an information providing method and an information providing system for providing Web pages collected in a Web archive by a Web archive server to a terminal of an information request source.

2. Description of the Related Art

Recently, various pieces of information are disclosed on websites on the Internet. However, the information on the Internet does not last long because it is constantly changed and deleted. In recent years, advanced nations have been experimentally performing activities to collect, accumulate, and store the information on the Internet for the purpose of protecting cultural properties on a permanent basis.

For example, “National Diet Library Web Archiving Project WARP (Internet <URL:http://warp.ndl.go.jp/>)” and “Way Back Machine (Internet <URL:http://www.archive.org/>)” disclose a Web archiving system that collects Web pages via the Internet and stores the collected Web pages in a Web archive. By “WARP”, a link to a Web page (for example, “a”) included in a Web page (for example, “A”) stored in the Web archive is rewritten as a link to the Web page (for example, “a”) stored in the Web archive. By “Way Back Machine”, a linked uniform resource locator (URL) described statically in a hypertext markup language (HTML) file is rewritten by a Web browser at the time of reference by adding a fixed “Java® Script” to the tail of the HTML file. Thus, the information accumulated in the Web archive can be referred to even if the Webpage on the Internet disappears.

However, in the methods of “WARP” and “Way Back Machine”, there is a problem that links to various Web pages stored in the Web archive cannot be traced. Specifically, to correctly jump from the Web page “A” to the associated Web page “a”, the linked address (URL) written in the Web page “A” stored in the Web archive needs to be rewritten. However, because links rewritable by the Web archiving system are limited to the links statically described in the HTML file, which can be analyzed and rewritten, jump to the associated Web page is possible only from the static link in the HTML file stored in the Web archive, and therefore jump to the associated Web page is not possible from the link by means of the “Java® Script” in the HTML file or a Web page other than the HTML file.

That is, with the conventional art, analysis and rewrite of the links present inside the Web page, such as various documents written with word processing software, various application data, and multimedia data present on the Internet, are not possible. Accordingly, the data cannot be referred to by correctly tracing the links of the Web pages stored in the Web archive. Further, the link dynamically generated by various scripts, even if it is described in the HTML file, cannot be analyzed and rewritten, which causes the same problem.

### SUMMARY OF THE INVENTION

It is an object of the present invention to at least partially solve the problems in the conventional technology.

A method according to one aspect of the present invention is for providing a Web page collected in a Web archive by a Web archive server to an information-requesting terminal. The method includes controlling including the information-requesting terminal controlling a transmission of an information acquisition request including an address of a requested Web page before collection and generation information or management information with which the generation information can be identified to the Web archive server; and providing including the Web archive server extracting a Web page corresponding to the address of the request Web page before collection and the generation information or the management information received from the transmission control unit from the Web archive, and the Web archive server providing extracted Web page to the information-requesting terminal.

A system according to another aspect of the present invention is for providing a Web page collected in a Web archive by a Web archive server to an information-requesting terminal. The information-requesting terminal includes a transmission control unit that controls a transmission of an information acquisition request including an address of a requested Web page before collection and generation information or management information with which the generation information can be identified to the Web archive server. The Web archive server includes an information providing unit that extracts a Web page corresponding to the address of the request Web page before collection and the generation information or the management information received from the,transmission control unit from the Web archive, and provides extracted Web page to the information-requesting terminal.

A computer-readable recording medium according to still another aspect of the present invention stores therein a computer program for providing a Web page collected in a Web archive by a Web archive server to an information-requesting terminal. The computer program causes a computer to execute controlling including the information-requesting terminal controlling a transmission of an information acquisition request including an address of a requested Web page before collection and generation information or management information with which the generation information can be identified to the Web archive server; and providing including the Web archive server extracting a Web page corresponding to the address of the request Web page before collection and the generation information or the management information received from the transmission control unit from the Web archive, and the Web archive server providing extracted Web page to the information-requesting terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an outline of an information providing system according to the present invention;

FIG. 2 is a schematic diagram for explaining characteristics of the information providing system according to the present invention;

FIG. 3 is a sequence diagram of a process operation of the information providing system according to the present invention;

FIG. 4 is a system diagram of a configuration of an information providing system according to a first embodiment of the present invention;

FIG. 5 is a flowchart of a PROXY-determining process procedure in a browser;

FIG. 6 is a flowchart of an operation of an archive PROXY;

FIG. 7 is a flowchart of an operation of an information providing processor;

FIG. 8 is another flowchart of an operation of the information providing processor;

FIG. 9 is still another flowchart of an operation of the information providing processor;

FIG. 10 is still another flowchart of an operation of the information providing processor; and

FIG. 11 is still another flowchart of an operation of the information providing processor.

### DETAILED DESCRIPTION OF THE PREFERRED EMBODIMENTS

Exemplary embodiments of an information providing method and an information providing system according to the present invention are explained in detail below with reference to the accompanying drawings. An information providing system according to a first embodiment of the present invention is explained following an explanation of an outline and characteristics of the information providing system according to the present invention, and various modified examples of the embodiment will be explained.

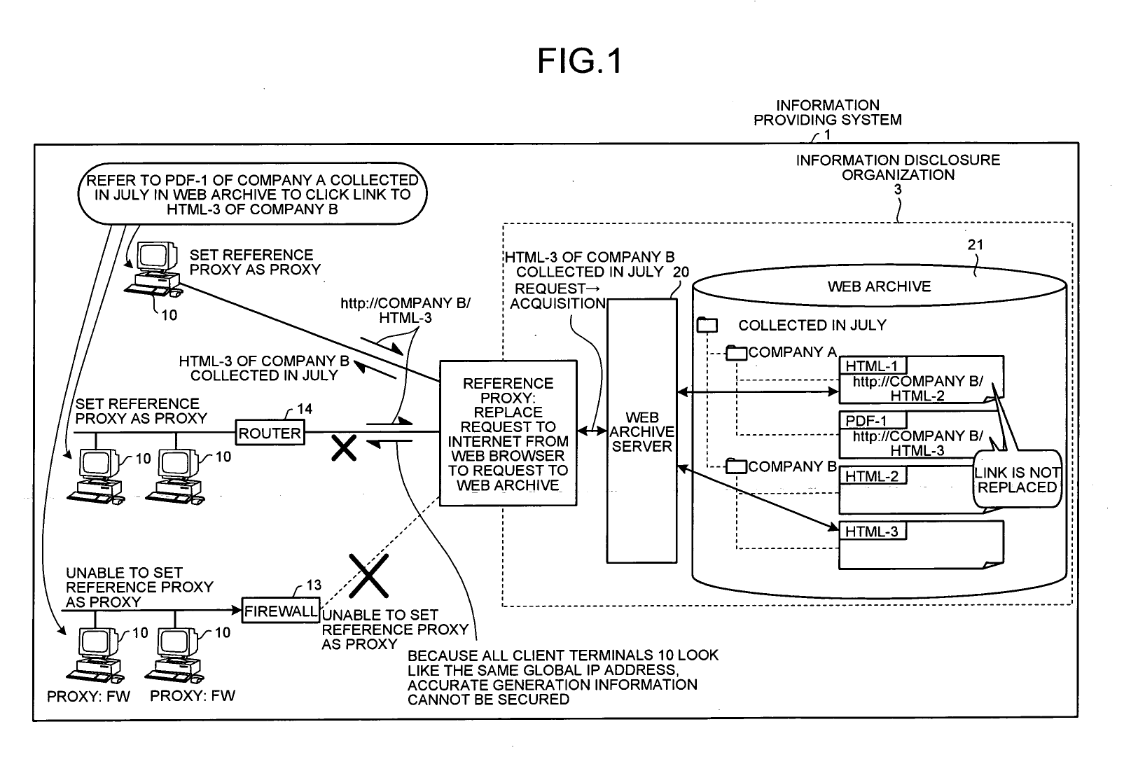

FIG. 1 is a schematic diagram for explaining the outline of the information providing system 1 according to the present invention. The information providing system 1 does not rewrite an internal link of a Web page to be accumulated in a Web archive 21 with a link in the Web archive, but accumulates internal links of collected contents in the Web archive 21 without rewriting it.

In the information providing system 1, to dissolve the problems in the conventional art, a Web-page acquisition request to the Internet is replaced by a request to a Web archive server 20 using a reference PROXY (URL replacement mechanism) positioned between a client terminal 10 and the Web archive server 20, so that various contents in the Web archive 21 can be referred to by tracing links according to the same operation as that of the Internet. To request replacement of the URL from the client terminal 10 to the reference PROXY (URL replacement mechanism), the PROXY of a Web browser needs to be defined in the reference PROXY.

Example implementations of the “reference PROXY” include a form in which the reference PROXY is placed on a server disclosed on the Internet and a form in which the reference PROXY is incorporated in user's Web browser (or a dedicated browser). When the reference PROXY is placed on the server disclosed on the Internet, as shown in FIG. 1, the Web archive can be referred to without installing new software, only by defining the reference PROXY as PROXY in the Web browser.

However, the information providing system 1 still has problems in that the client terminal 10 via a firewall (PROXY) cannot use the reference PROXY, and that the client terminal 10 via a broadband router (IP masquerade) cannot refer to the Web archive simultaneously and normally.

To explain more specifically, the reason why the client terminal 10 via a firewall cannot use the reference PROXY is that PROXY outside the firewall cannot be defined from inside the network such as a local area network (LAN) and the Intranet.

Furthermore, the reason why the client terminal 10 via a broadband router cannot refer to the Web archive simultaneously and normally is that because the reference PROXY (URL replacement mechanism) on the Internet holds generation information during reference using the global IP address of a source of access as a key, when a plurality of accesses are attempted from the same global IP address, the generation information accessed last is held in the reference PROXY, thereby making it difficult to specify which client terminal is the source of information request.

Therefore, in the information providing system 1, the one that can use the reference PROXY (URL replacement mechanism) disclosed on the Internet is only the client terminal directly connected to the Internet. Other client terminals need to install Web archive access software of the reference PROXY (including the URL replacement mechanism). In an information disclosure organization 3, the access software needs to be prepared for each operating system (OS) of the client terminal 10, and preparation of the access software corresponding to all of the OS will lead to a decrease in cost performance.

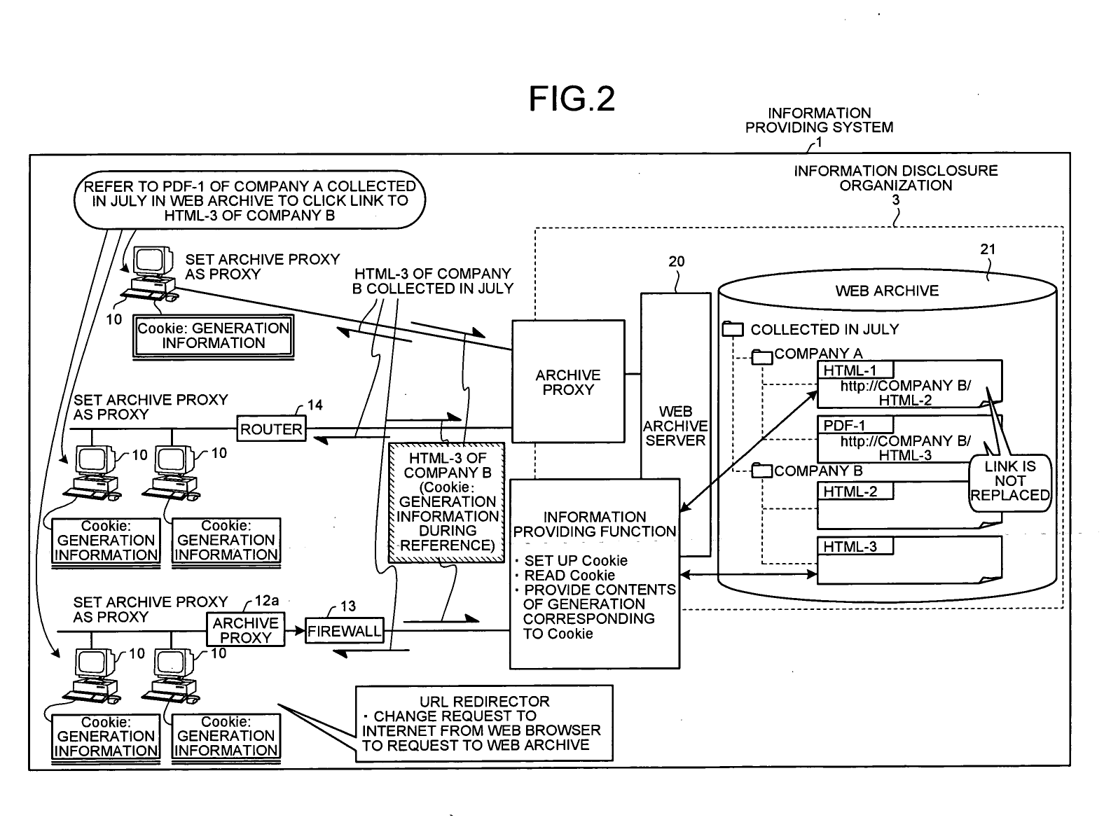

As shown in FIG. 2, the information providing system 1 according to the present invention has a main characteristic in a series of processes in which the client terminal 10 is controlled to transmit an information acquisition request including an address before collection and generation information of a Web page as a request target to the Web archive server 20, and the Web archive server 20 extracts the Web page corresponding to the transmitted address before collection and generation information of the Web page from the Web archive 21 and provides the extracted Web page to the client terminal 10. According to the series of processes, various Web page links stored in the Web archive can be traced even from the client terminal via a firewall or the client terminal via a broadband router. In the present embodiment, an original address at the time of being present on the Internet is hereunder referred to as an “address before collection” and an original domain address at the time of being present on the Internet is referred to as a “domain address before collection”.

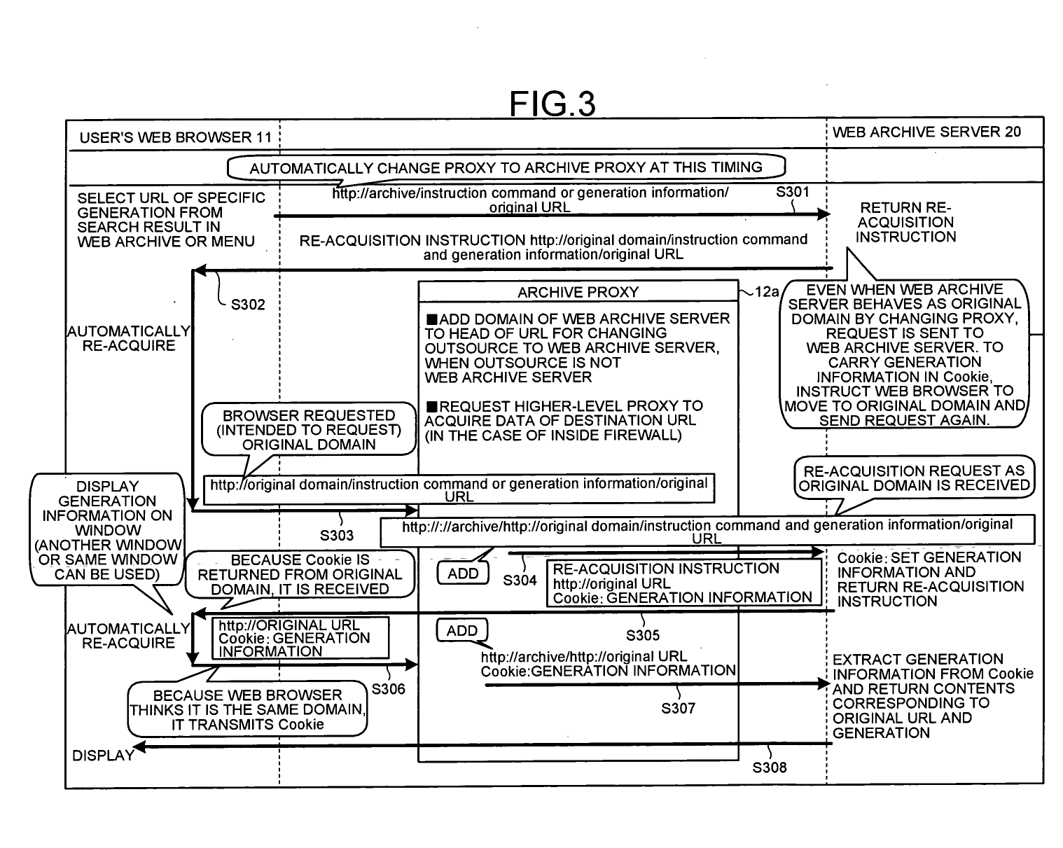

The main characteristic is specifically explained with reference to FIG. 3. FIG. 3 is a sequence diagram of the process operation of the information providing system according to the present invention. As shown in FIG. 3, upon reception of a URL selection of the Web page of a specific generation from a search result of the Web archive 21 or a menu, the client terminal 10 sends a Web page acquisition request http://archive/instruction command/generation information/original URL (URL before collection) to the Web archive server 20 (step S301). At this time, in the client terminal 10, a setup PROXY is changed from a firewall 13 to an archive PROXY 12a (details thereof will be explained in the first embodiment).

Upon reception of the Web page acquisition request, the Web archive server 20 instructs the client terminal to send the Web page acquisition request again to the original domain of the Web page as the request target (step S302), and the client terminal 10 re-sends the Web page acquisition request “http://original domain/instruction command/generation information/original URL” to the original domain, upon reception of the re-access instruction to the original domain (step S303).

The archive PROXY 12a defined as the PROXY of the client terminal 10 adds http://archive to “http://original domain/instruction command/generation information/original URL” to change an outsource to the Web archive server 20, and controls to transmit the Web page acquisition request to the Web archive server 20 (step S304).

The reason why the Web archive server 20 instructs the client terminal to send the Web page acquisition request again to the original domain is that the Web archive server 20 behaves as the original domain using the archive PROXY 12a switched as the setup PROXY by the client terminal so that the client terminal 10 identifies the Web archive server 20 as the same source domain.

Returning to the explanation with reference to FIG. 3, upon reception of the re-acquisition request as the original domain from the client terminal 10, the Web archive server 20 issues “Cookie”, in which the generation information of the Web page is set, and instructs the client terminal to send the Web page acquisition request again to the original URL “http://original URL” (step S305).

Upon reception of the re-access instruction to the original URL, the client terminal 10 re-send the Web page acquisition request “http://original URL” to the original URL (step S306). At this time, because the client terminal 10 identifies that the re-acquisition instruction is from the same domain, the generation information of the “Cookie” is also transmitted to the Web archive server 20.

The archive PROXY 12a adds “http://archive” in front of the original URL “http://original URL”, and controls to transmit the Web page acquisition request to the Web archive server 20 (step S307).

Upon reception of the re-acquisition request of the original URL, the Web archive server 20 extracts the generation information from the “Cookie” and extracts the Web page corresponding to the original URL and the generation from the Web archive 21, to transmit the extracted Web page to the client terminal 10 (step S308).

In the information providing system 1 according to the present invention, the client terminal 10 is controlled to transmit the information acquisition request including the address before collection and the generation information of the Web page as the request target to the Web archive server 20, and the Web archive server 20 extracts the Web page corresponding to the transmitted address before collection and generation information of the Web page from the Web archive 21 and provides the extracted Web page to the client terminal 10. Accordingly, management of the generation information and replacement of the URL can be performed by respective devices (the client terminal 10 and the Web archive server 20) in a distributed manner, and, as the characteristics of the invention described above, various Web page links stored in the Web archive can be traced even from the client terminal via a firewall or the client terminal via a broadband router.

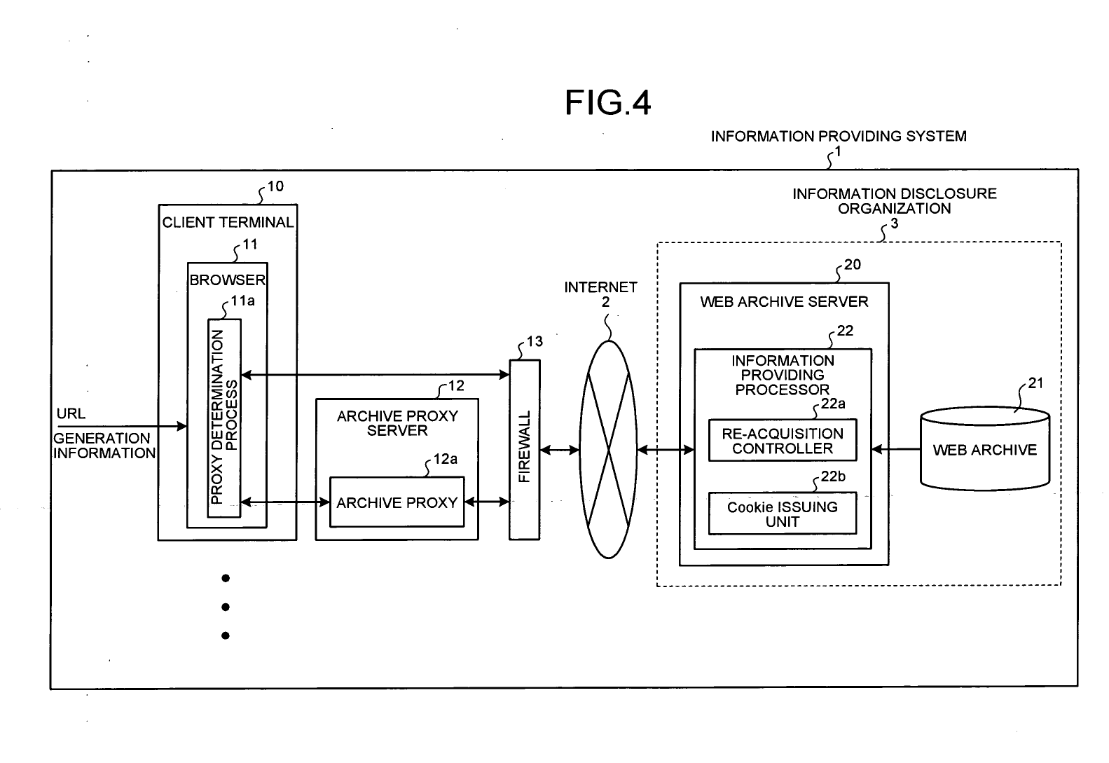

The information providing system 1 according to the first embodiment is explained below. Respective functions of the client terminal and the Web archive server in the information providing system 1 are explained with reference to FIG. 4, and operations of these functions will be explained with reference to appended flowcharts.

FIG. 4 is a system diagram of the configuration of the information providing system 1 according to the first embodiment. In the information providing system 1, the client terminal 10 and the Web archive server 20 are communicably connected with each other via the Internet 2.

The client terminal 10 is an information processor that holds a browser (application software) 11 for browsing the Web page in an internal memory such as a central processing unit (CPU), downloads an HTML file, an image file, a music file, and the like from the Internet 2, analyzes a layout, and outputs the file. The client terminal 10 is connected to the firewall (higher-level PROXY) that monitors communication with an external network and an archive PROXY server 12 that performs URL redirecting process explained later.

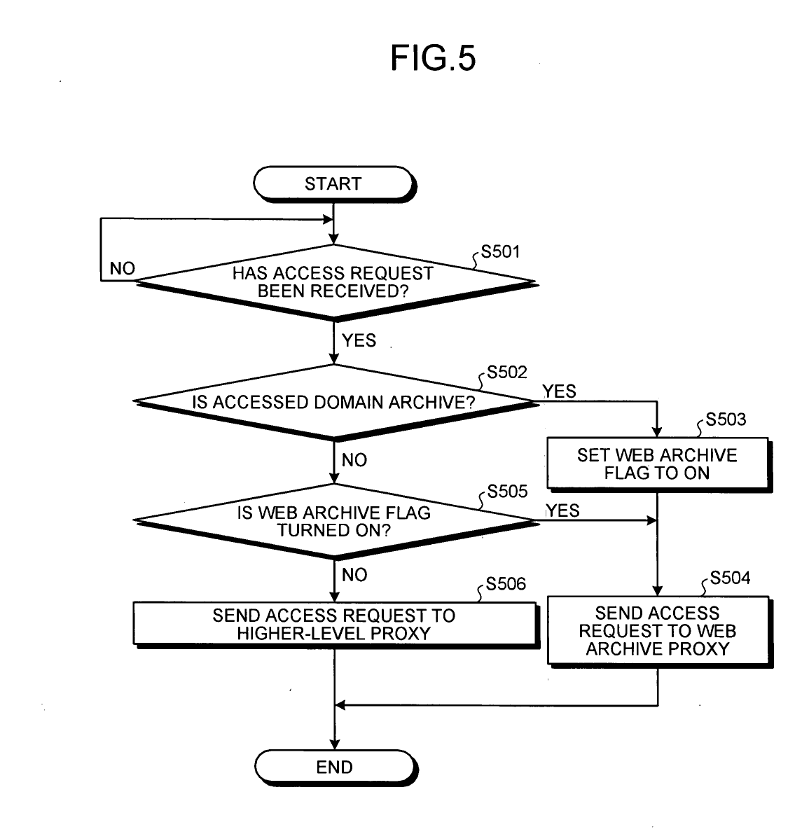

An operation of the browser 11 in the client terminal 10 is explained next. FIG. 5 is a flowchart of a PROXY-determining process procedure in the browser 11. As shown in FIG. 5, upon reception of an access request to the Internet 2 (external network) (YES at step S501), in a PROXY determination process 11a in which a PROXY rule in the internal network is defined, it is monitored whether the access request indicates an access to navigation of the Web archive or to an URL described in a search result list HTML (step S502).

More specifically, in the PROXY determination process 11a, it is monitored whether the access request is relative to the content of the Web archive 21 and the content is an URL suggesting reference to a specific URL at specific date and time (for example, “http://ARCHIVE/view/generation/http://originalURL” or the like), using http://ARCHIVE/view as a key.

When the accessed domain is “http://ARCHIVE/view” (YES at step S502), in the PROXY determination process 11a, a Web archive flag is set to “ON” (step S503), and the access request is sent to the archive PROXY 12a (step S504).

Although the accessed domain is not “http://ARCHIVE/view”, when the Web archive flag is “ON” (NO at step S502, and YES at step S505), the access request is sent to the archive PROXY 12a (step S504).

When the Web archive flag is set to “ON”, all the URL requests from the window of the browser and a child window generated from the window are directed to the archive PROXY server 12. When the browser 11 is finished or restarted, the Web archive flag is cleared.

On the other hand, when the accessed domain is not “http://ARCHIVE/view” and the Web archive flag is “OFF” (NO at step S502 and NO at step S505), in the PROXY determination process 11a, it is determined as normal Internet browsing and the access request is sent to a higher-level PROXY 13 (step S506).

Thus, in the PROXY determination process 11a in the browser 11, it is determined to which of the higher-level PROXY (firewall) 13 and the archive PROXY 12a an access request is to be sent.

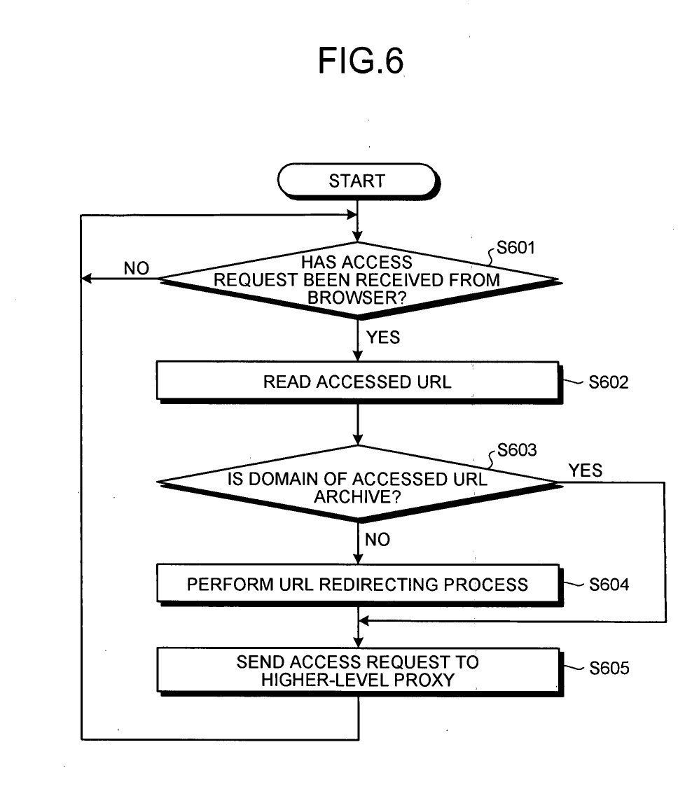

The operation of the archive PROXY is explained next. FIG. 6 is a flowchart of the operation of the archive PROXY. As shown in FIG. 6, upon reception of the access request from the browser 11 (YES at step S601), the archive PROXY 12a reads the URL to be accessed (step S602).

When the domain of the accessed URL is not http://ARCHIVE/ (YES at step S603), the archive PROXY 12a performs the URL redirecting process to add the URL “http://ARCHIVE/any/” of the Web archive server 20 in front of the original UEL (URL before collection) of the Web page to be requested or the original domain (step S604), and sends an access request to the higher-level PROXY 13 (step S605).

By performing the URL redirecting process to add the address of the Web archive server to the address before collection of the Web page to be requested to control so that an information acquisition request is transmitted to the Web archive server, even the client terminal via a firewall can change the access to the address before collection present on the network to an access to the address of the Web archive server.

The URL redirecting function of the archive PROXY 12a can be completed by the client terminal. However, if the URL redirecting function of the archive PROXY 12a is executed by a desired server apparatus arranged in the internal network, the Web archive access software corresponding to the client terminal 10 need not be installed for each type of the OS, thereby enabling the Web archive to be accessed without changing the environment of the client terminal 10.

The Web archive server 20 is a server apparatus that collects Web pages present on the Internet in the Web archive 21 using a Web robot or the like to provide the Web pages collected in the Web archive 21 to the client terminal 10, and includes an information, providing processor 22 as a functional unit closely related to the present invention.

The information providing processor 22 extracts the Web page corresponding to the original URL (address before collection) and the generation information of the Web page received from the client terminal 10 from the Web archive 21. The information providing processor 22 then provides the extracted Web page to the client terminal 10.

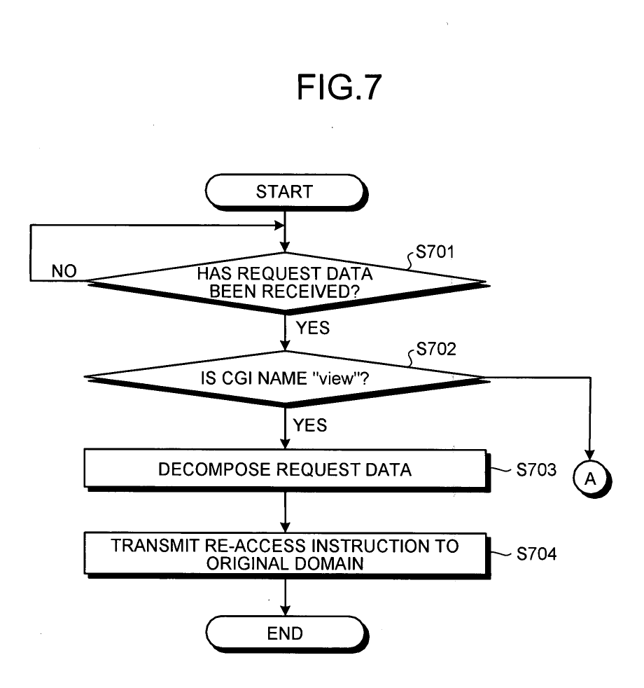

The operation of the information providing processor 22 is explained in detail with reference to FIGS. 7 to 11. FIGS. 7 to 11 are flowcharts of the operation of the information providing processor 22. As shown in FIG. 7, upon reception of Web page request data from the browser 11 (YES at step S701), the information providing processor 22 identifies whether the CGI name included in the request data is “view” (step S702).

When the CGI name included in the Web page request data is “view” (YES at step S702), the information providing processor 22 decomposes the request data (PATH_INFO) into generation, original domain, and original URI (step S703).

A re-acquisition controller 22a embeds a CGI instruction command “Set-DateInTheWebArchive” for setting the generation acquired by decomposition of the data in the “Cookie” in the URL with the original domain set as a destination, and transmits a re-acquisition instruction to the original domain, designating the embedded URL “http://original domain/Set-DateInTheWebArchive/generation/original URL” as a “Location” (step S704). The re-acquisition instruction to the original domain is provided to issue the “Cookie” by the original domain.

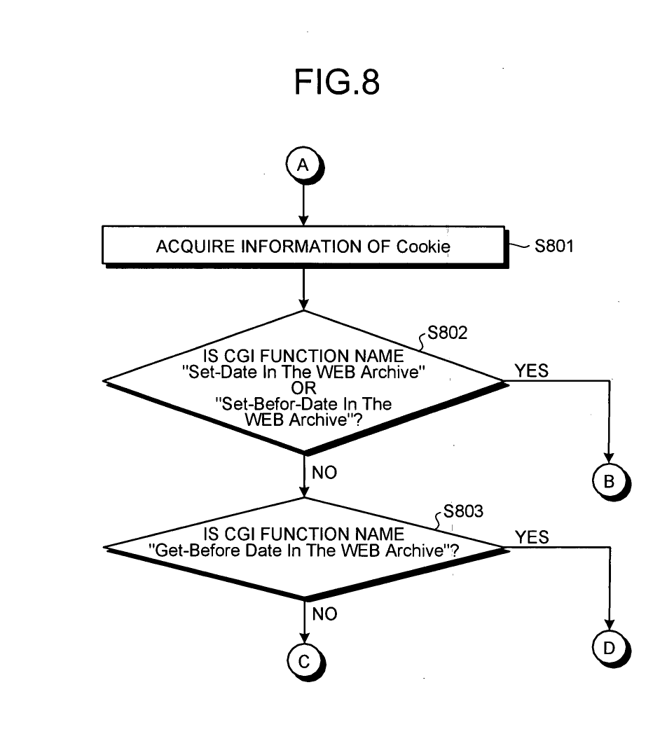

On the other hand, when the CGI name included in the Web page request data is “any” (NO at step S702), as shown in FIG. 8, the information providing processor 22 reads the information of the “Cookie”, that is, “date” (generation information of “Cookie”) and “sated” (whether the “Cookie” has been set) (step S801).

After the information of the “Cookie” has been read, the information providing processor 22 performs processes corresponding to the CGI function names “Set-DateInTheWebArchive”, “Set-Before- DateInTheWebArchive”, “original URL”, and “Get-BeforeDateInTheWebArchive” included in the Web page request data, so that the generation information can be carried even when the Web page as the request target has been shifted to another domain.

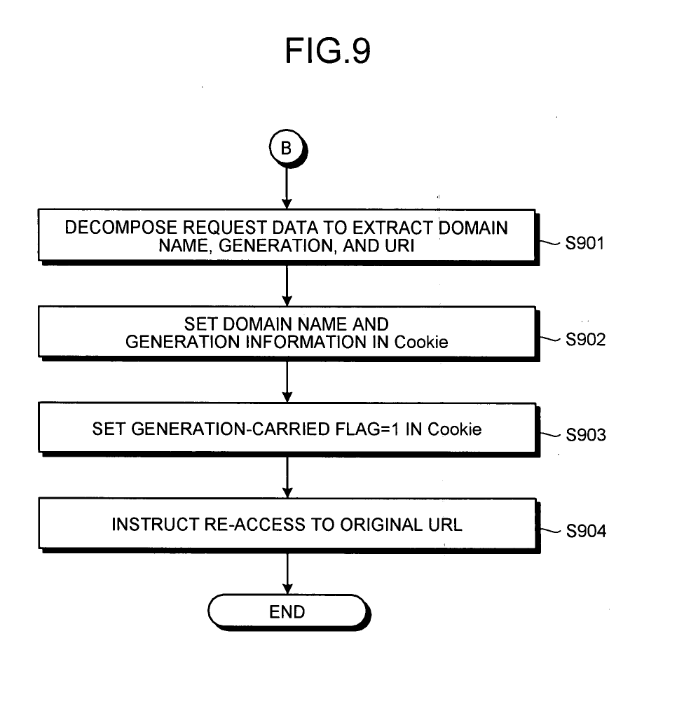

These CGI functions are briefly explained. “Set-DateInTheWebArchive” is for setting the generation in the “Cookie” so that the generation information can be carried at the time of subsequent reference and returning the “Location” to the client terminal 10 to make the original URL as a current URL (see FIG. 9). “Set-Before-DateInTheWebArchive” is for setting the generation in the URL in the “Cookie” and returning the re-acquisition instruction with the original URL to the client terminal 10 (see FIG. 9).

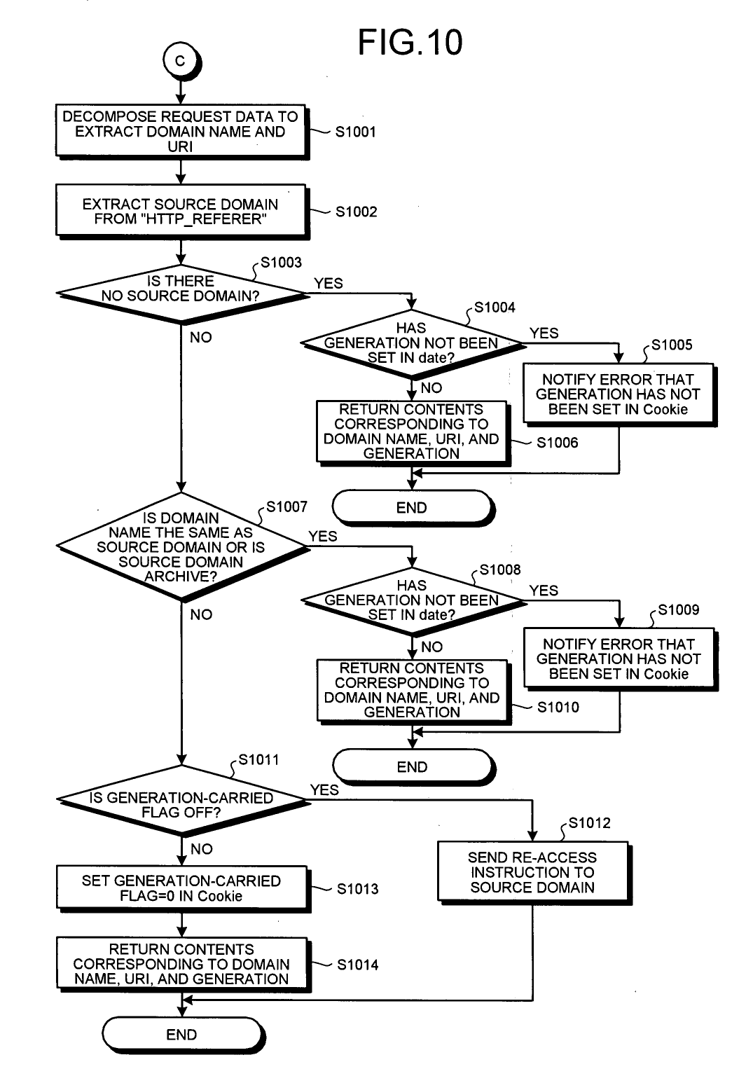

The “original URL” is for extracting the contents (Web page) indicated by the original URL from the Web archive 21 based on the generation set in the “Cookie” and returning the extracted contents to the client terminal 10 (see FIG. 10). Note that when a shift is performed from a page of another domain by tracing the link, the browser 11 of the client terminal 10 does not provide the “Cookie”. Therefore, the instruction command “Get-BeforeDateInTheWebArchive” is embedded in the URL with the domain before the shift set as a destination, and the embedded URL is designated as the “Location” to return the re-access instruction to the domain before the shift to the client terminal 10.

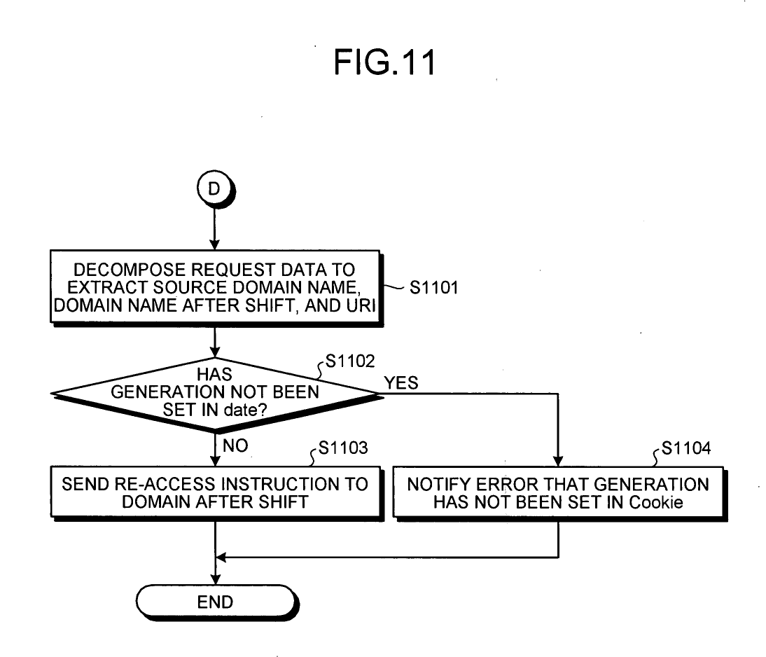

The “Get-Before-DateInTheWebArchive” is for extracting the generation from the domain before the shift and returning the re-access instruction to the domain after the shift to the client terminal 10 so that the “Cookie” is set by the domain after the shift (see FIG. 11).

Returning to the explanation with reference to FIG. 8, when the CGI function name is “Set-DateInTheWebArchive” or “Set-Before-DateInTheWebArchive” (YES at step S802), as shown in FIG. 9, the information providing processor 22 decomposes the request data “REQUEST_URI” to extract the domain name, generation, and URI (step S901).

A Cookie issuing unit 22b sets the generation (=DateInTheWebArchive) and the original domain (=domain) in the “Cookie” (step S902), and sets generation-carried flag=1 in the “Cookie” (step S903). Subsequently, the information providing processor 22 instructs the client terminal 10 to re-access the original URL, designating “http://original domain/original URI” as the “Location” (step S904).

On the other hand, when the CGI function name is “original URL” (NO at step S802 and NO at step S803), as shown in FIG. 10, the information providing processor 22 decomposes the request data (REQUEST_URI) to extract the domain name and the URI (step S1001), and extract the source domain from “HTTP_REFERER” (step S1002).

At this time, if there is no source domain and the generation (=DateInTheWebArchive) has not been set in the “Cookie” (YES at step S1003 and YES at step S1004), the information providing processor 22 notifies the client terminal 10 of such an error that the generation has not been set in the “Cookie” (step S1005).

On the other hand, even without the source domain, if the generation (=DateInTheWebArchive) has been set in the “Cookie” (YES at step S1003 and NO at step S1004), the information providing processor 22 returns the contents (Web page) corresponding to the domain name, URI, and generation to the client terminal 10 (step S1006).

When there is the source domain, the domain name is the same as the source domain or the source domain is “ARCHIVE”, and the generation (=DateInTheWebArchive) has not been set in the “Cookie” (NO at step S1003, YES at step S1007, and YES at step S1008), the information providing processor 22 notifies the client terminal 10 of an error that the generation has not been set in the “Cookie” (step S1009).

On the other hand, when there is the source domain, the domain name is the same as the source domain or the source domain is “ARCHIVE”, and the generation (=DateInTheWebArchive) has been set in the “Cookie” (NO at step S1003, YES at step S1007, and NO at step S1008), the information providing processor 22 returns the contents (Web page) corresponding to the domain name, URI, and generation to the client terminal 10 (step S1010).

When a shift is performed from the other domain and the generation-carried flag is “OFF” (NO at step S1003, NO at step S1007, and YES at step S1011), the browser 11 of the client terminal 10 does not provide the “Cookie”. Accordingly, the re-acquisition controller 22a embeds the instruction command “Get-BeforeDateInTheWebArchive” in the URL with the domain before the shift set as a destination, and the embedded URL is designated as the “Location” to send the re-acquisition instruction to the domain before the shift to the client terminal 10 (step S1012).

On the other hand, when a shift is performed from the other domain and the generation-carried flag is “ON” (NO at step S1003, NO at step S1007, and NO at step S1011), the information providing processor 22 sets generation-carried flag=0 in the “Cookie” (step S1013), and returns the contents (Web page) corresponding to the-domain name, URI, and generation to the client terminal 10 (step S1014).

Returning to the explanation with reference to FIG. 8, when the CGI function name is “Get-BeforeDateInTheWebArchive” (NO at step S802 and YES at step S803), as shown in FIG. 11, the information providing processor 22 decomposes the request data (REQUEST_URI) to extract the source domain name, the domain name after the shift, and the URI (step S1101).

At this time, when the generation (=DateInTheWebArchive) has been set in “Cookie” (NO at step S1102), the re-acquisition controller 22a embeds the CGI instruction command “Set-Before-DateInTheWebArchive” for setting the generation in the “Cookie” in the URL with the domain after the shift set as a destination, and instructs the client terminal 10 to re-acquire the domain after the shift, designating the embedded URL http://domain after shift/Set-Before-DateInTheWebArchive/generation/original URI” as the “Location” (step S1103).

When the generation (=DateInTheWebArchive) has not been set in the “Cookie” (YES at step S1102), the information providing processor 22 notifies the client terminal 10 of an error that the generation has not been set in the “Cookie” (step S1104).

As described above, in the information providing system 1 according to the first embodiment, management of the generation information and replacement of the URL can be performed by respective devices (the client terminal 10 and the Web archive server 20) in a distributed manner, and various Web page links stored in the Web archive can be traced even from the client terminal via a firewall or the client terminal via a broadband router.

According to the information providing system 1 in the first embodiment, the URL redirecting process for adding the address of the Web archive server 20 to the original URL of the requested Web page is performed, to control the client terminal to transmit the Web page acquisition request to the Web archive server 20. Accordingly, even the client terminal via a firewall can change the access to the address before collection present on the network to the access to the address of the Web archive server.

According to the information providing system 1 in the first embodiment, the Web archive server 20 instructs the client terminal 10 to retransmit the Web page acquisition request to the original domain of the Web page specified by the client terminal 10 as a request target, and issues the Cookie, in which the generation information of the Web page is set, to the client terminal 10, thereby controlling so that the original URL of the Web page and the generation information in the issued “Cookie” are transmitted to the Web archive server 20. Accordingly, the generation information can be carried in the Cookies, and even when a plurality of accesses are made from the same IP address, the Web archive can be referred to.

In association therewith, the “Cookie” can be carried between different servers in different domains, and therefore users can receive common services (common use of shopping points or the like) by sharing information using the present invention in a website, which has been present alone, for example, in the field of Internet shopping websites. Further, in the field of learning, service matched with the user can be provided by displaying common information or sharing users' specific information (such as the way of thinking and preferences) in association with another dictionary website, at the time of reference of contents in an encyclopedia or the like.

While the first embodiment of the present invention has been explained above, variously modified embodiments other than the first embodiment can be made without departing from the scope of the technical spirit of the appended claims.

For example, in the first embodiment, the URL redirecting process for adding the address of the Web archive server 20 to the original URL of the requested Web page is performed to change the access to the address before collection present on the network to the access to the address of the Web archive server. However, the present invention is not limited thereto, and a Web page acquisition target can be transmitted to the Web archive server 20 defined as the PROXY of the client terminal 10. The access from the client terminal can be then controlled exclusively by the Web archive server.

In the present invention, the generation information of the Web page specified as the request target can be output to the client terminal 10. For example, when navigation to the Web archive or an access to the URL described in the search result list HTML is detected, a window in which the generation information is drawn is displayed. The window for displaying the generation information can be the same as the current window or can be another window.

The generation information can be output at the time of outputting the Web page stored in the Web archive, and the generation in the archive accessed by the client terminal can be easily identified.

In the first embodiment, an example in which the generation information itself is set in the “Cookie” has been explained. However, the present invention is not limited thereto, and the generation information can be made identifiable by the client terminal 10 and the Web archive server 20 as in the first embodiment by setting the management information (for example, a session ID) capable of specifying the generation information in the “Cookie”.

Among the respective process described in the embodiments, all or a part of the processes explained as being performed automatically can be performed manually, or all or a part of the processes explained as being performed manually can be performed automatically by a known method. In addition, the process procedures, control procedures, specific names, and information including various kinds of data and parameters shown in the present specification or the drawings can be optionally changed unless otherwise specified.

The respective constituent elements of the units or devices shown in the drawings are functionally conceptual, and physically the same configuration is not always necessary. That is, the specific mode of distribution and integration of the units or devices is not limited to the shown ones, and all or a part thereof can be functionally or physically distributed or integrated in an optional unit, according to various kinds of load and the status of use. All or an optional part of various process functions performed by the respective units or devices can be realized by a CPU or a program analyzed and executed by the CPU, or can be realized as hardware by a wired logic. As described above, according to one aspect of the present invention, an information-requesting terminal transmits an information acquisition request including the address before collection of the requested Web page and the generation information or management information capable of specifying the generation information to the Web archive server, and the Web archive server extracts a Web page corresponding to the transmitted address before collection of the Web page and generation information or management information capable of specifying the generation information from the Web archive, and provides the extracted Web page to the information-requesting terminal. Accordingly, an information providing method that can trace various Web page links stored in the Web archive can be obtained. Further, in association therewith, by performing management of the generation information and replacement of the URL by respective devices (the client terminal 10 and the Web archive server 20) in a distributed manner, various Web page links stored in the Web archive can be traced even from the information-requesting terminal via a firewall or the information-requesting terminal via a broadband router.

Furthermore, according to another aspect of the present invention, it is controlled such that the information acquisition request is transmitted to the Web archive server by performing the URL redirecting process for adding the address of the Web archive server to the address before collection of the requested Web page. Accordingly, an information providing method can be obtained by which even the information-requesting terminal via a firewall can change the access to the address before collection present on the network to an access to the address of the Web archive server.

Moreover, according to still another aspect of the present invention, the Web archive server instructs the information-requesting terminal to retransmit the information acquisition request to the domain address before collection of the Web page specified by the client terminal as a request target, and issues the Cookie, in which the generation information of the Web page or the management information capable of specifying the generation information is set, to the information-requesting terminal, thereby controlling so that the address before collection of the Web page and the generation information or the management information capable of specifying the generation information in the issued “Cookie” are transmitted to the Web archive server. Accordingly, an information providing method can be obtained, by which the generation information (or the management information capable of specifying the generation information) can be carried in the Cookies, and even when a plurality of accesses are made from the same IP address, the Web archive can be referred to.

Furthermore, according to still another aspect of the present invention, the generation information of the Web page specified as the request target or the management information capable of specifying the generation information is output to the information-requesting terminal. Accordingly, an information providing method can be obtained, by which the generation information (or the management information capable of specifying the generation information) can be output at the time of outputting the Web page stored in the Web archive, and the generation in the archive accessed by the information-requesting terminal can be easily identified.

Moreover, according to still another aspect of the present invention, the information-requesting terminal transmits an information acquisition request including the address before collection of the requested Web page and the generation information or management information capable of specifying the generation information to the Web archive server, and the Web archive server extracts a Web page corresponding to the transmitted address before collection of the Web page and generation information or management information capable of specifying the generation information from the Web archive, and provides the extracted Web page to the information-requesting terminal. Accordingly, an information providing system that can trace various Web page links stored in the Web archive can be obtained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of providing a Web page collected in a Web archive by a Web archive server to an information-requesting terminal, the method comprising:
controlling including the information-requesting terminal controlling a transmission of an information acquisition request including an address of a requested Web page before collection and generation information or management information with which the generation information can be identified to the Web archive server; and
providing including the Web archive server extracting a Web page corresponding to the address of the request Web page before collection and the generation information or the management information received from the transmission control unit from the Web archive, and the Web archive server providing extracted Web page to the information-requesting terminal.

2. The method according to claim 1, wherein the controlling includes performing a uniform-resource-locator redirecting process of adding an address of the Web archive server to the address of the requested Web page before collection.

3. The method according to claim 1, wherein the Web archive server is a Web archive server defined as a PROXY of the information-requesting terminal.

4. The method according to claim 1, wherein
the providing includes the Web archive server instructing the information-requesting terminal to retransmit the information acquisition request to the address of the requested Web page before collection, and the Web archive server issuing a Cookie in which the generation information or the management information is set to the information-requesting terminal, and
the controlling includes the information-requesting terminal controlling a transmission of the address of the requested Web page before collection and the generation information or the management information capable of specifying the generation information in the Cookie issued at the issuing to the Web archive server.

5. The method according to claim 1 wherein at least one of the controlling and the providing further includes controlling an output of the generation information or the management information of the requested Web page to the information-requesting terminal.

6. A system for providing a Web page collected in a Web archive by a Web archive server to an information-requesting terminal, wherein
the information-requesting terminal includes a transmission control unit that controls a transmission of an information acquisition request including an address of a requested Web page before collection and generation information or management information with which the generation information can be identified to the Web archive server, and
the Web archive server includes an information providing unit that extracts a Web page corresponding to the address of the request Web page before collection and the generation information or the management information received from the transmission control unit from the Web archive, and provides extracted Web page to the information-requesting terminal.

7. The system according to claim 6, wherein the transmission control unit controls the transmission of the information acquisition request to the Web archive server by performing a uniform-resource-locator redirecting process of adding an address of the Web archive server to the address of the requested Web page before collection.

8. The system according to claim 6, wherein the Web archive server is a Web archive server defined as a PROXY of the information-requesting terminal.

9. The system according to claim 6, wherein
the Web archive server further includes a Cookie issuing unit that instructs the information-requesting terminal to retransmit the information acquisition request to the address of the requested Web page before collection, and issues a Cookie in which the generation information or the management information is set to the information-requesting terminal, and
the transmission control unit controls a transmission of the address of the requested Web page before collection and the generation information or the management information capable of specifying the generation information in the Cookie issued by the Cookie issuing unit to the Web archive server.

10. The system according to claim 6 wherein at least one of the information-requesting terminal and the Web archive server further includes an output control unit that controls an output of the generation information or the management information of the requested Web page to the information-requesting terminal.

11. A computer-readable recording medium that stores therein a computer program for providing a Web page collected in a Web archive by a Web archive server to an information-requesting terminal, the computer program causing a computer to execute:
controlling including the information-requesting terminal controlling a transmission of an information acquisition request including an address of a requested Web page before collection and generation information or management information with which the generation information can be identified to the Web archive server; and
providing including the Web archive server extracting a Web page corresponding to the address of the request Web page before collection and the generation information or the management information received from the transmission control unit from the Web archive, and the Web archive server providing extracted Web page to the information-requesting terminal.

12. The computer-readable recording medium according to claim 11, wherein the controlling includes performing a uniform-resource-locator redirecting process of adding an address of the Web archive server to the address of the requested Web page before collection.

13. The computer-readable recording medium according to claim 11, wherein the Web archive server is a Web archive server defined as a PROXY of the information-requesting terminal.

14. The computer-readable recording medium according to claim 11, wherein
the providing includes the Web archive server instructing the information-requesting terminal to retransmit the information acquisition request to the address of the requested Web page before collection, and the Web archive server issuing a Cookie in which the generation information or the management information is set to the information-requesting terminal, and
the controlling includes the information-requesting terminal controlling a transmission of the address of the requested Web page before collection and the generation information or the management information capable of specifying the generation information in the Cookie issued at the issuing to the Web archive server.

15. The computer-readable recording medium according to claim 11 wherein at least one of the controlling and the providing further includes controlling an output of the generation information or the management information of the requested Web page to the information-requesting terminal.
